(19) United States
(12) Patent Application Publication
(10) Pub. No.: US 2015/0204432 A1
(43) Pub. Date: Jul. 23, 2015

(54) DIFFERENTIAL GEAR UNIT OF VEHICLE

(71) Applicant: Toyota Jidosha Kabushiki Kaisha, Toyota-shi (JP)

(72) Inventor: Takahiro Yoshimura, Toyota-shi (JP)

(21) Appl. No.: 14/600,040

(22) Filed: Jan. 20, 2015

(30) Foreign Application Priority Data
Jan. 22, 2014 (JP) 2014-009412

(51) Int. Cl. F16H 48/40; F16H 48/08

(52) U.S. Cl. CPC F16H 48/40; F16H 48/08; F16H 2048/082

(57) ABSTRACT

A biasing device is disposed between a back face of each of side gears and a differential case in a pre-loaded condition. A cylindrical portion is provided in the differential case and is configured to permit a drive shaft to be fitted therein. The cylindrical portion has a spiral groove provided in an inner circumferential surface thereof. Each of a cutting start point of the spiral groove and a cutting end point of the spiral groove is spaced by a predetermined degree in a circumferential direction of the cylindrical portion from a point. The point is on a line on which a plane intersects with the inner circumferential surface of the cylindrical portion. The point is at an end of the cylindrical portion. The plane includes an axis of the cylindrical portion and a mesh point at which the side gear meshes with the pinion gear.

### INCORPORATION BY REFERENCE

The disclosure of Japanese Patent Application No. 2014-009412 filed on Jan. 22, 2014 including the specification, drawings and abstract is incorporated herein by reference in its entirety.

### BACKGROUND OF THE INVENTION

1. Field of the Invention

The invention relates to a differential gear unit of a vehicle, and particularly relates to improvement of the durability of the differential gear unit.

2. Description of Related Art

In a vehicle, a differential gear unit of a bevel gear type, for example, is provided for giving a difference in the rotational speed to right and left wheels during turning of the vehicle, for example, so as to achieve smooth turning. In a differential gear unit as described in Japanese Utility Model Application Publication No. 6-80943 (JP 6-80943 U), disc springs are disposed between back faces of side gears and inner surfaces of a differential case in a pre-loaded condition, so as to reduce backlash that appears between the side gears and pinion gears.

### SUMMARY OF THE INVENTION

In the differential gear unit as described in JP 6-80943 U, the disc springs are disposed as biasing means between the back faces of the side gears and the inner surfaces of the differential case. In this type of differential gear unit, when the differential gear unit performs a differential operation, and the vehicle is traveling in a low torque region, in particular, the side gears of the differential gear unit may vibrate (move) in the axial direction of the side gears. At this time, a drive shaft fitted in the side gear of the differential gear unit likewise vibrates in the axial direction, and the drive shaft slides against an inner circumferential surface of a cylindrical portion formed in the differential case so as to hold the drive shaft, in the axial direction of the side gear. If the contact pressure P of a sliding portion that appears when the drive shaft slides against the cylindrical portion of the differential case is increased, wear or seizure may occur in the sliding portion.

Further, in the differential gear unit provided with the biasing means, such as a disc spring, between each side gear and the differential case, it has been found that a difference arises in the amount of displacement of the biasing means due to a phase difference or meshing error in the upper and lower mesh points of the side gear and the pinion gears, resulting in a phenomenon that the side gear is inclined. Accordingly, the drive shaft fitted in the side gear is likewise inclined, and the contact pressure of the sliding portion between the cylindrical portion of the differential case and the drive shaft is likely to be increased.

Generally, a spiral groove for lubrication is formed in an inner circumferential surface of each cylindrical portion of the differential case, such that the groove communicates with the inside and outside of the differential case. If the phase in the circumferential direction of a mesh point between one of the pinion gears and one of the side gears of the differential gear unit is the same as or close to the phase in the circumferential direction of a cutting start point or a cutting end point of the spiral groove formed in the cylindrical portion of the differential case, the contact area of the sliding portion between the differential case and the drive shaft is reduced, and the contact pressure of the sliding portion is increased. Accordingly, wear or seizure is likely to occur in the sliding portion.

The invention provides a differential gear unit of a vehicle having a biasing means, such as a disc spring, disposed between a back face of a side gear and an inner surface of a differential case, which gear unit is less likely or unlikely to suffer from wear and seizure.

A differential gear unit according to a first aspect of the invention includes a differential case, at least two pinion gears, a pair of side gears, a drive shaft, a biasing device, and a cylindrical portion. The two pinion gears are fitted on a pinion shaft fixed to the differential case. The side gears mesh with the pinion gears. The drive shaft is fitted in and connected to each of the side gears. The biasing device is disposed between a back face of each of the side gears and the differential case in a pre-loaded condition.

The cylindrical portion is provided in the differential case. The cylindrical portion is configured to permit the drive shaft to be fitted in the cylindrical portion. The cylindrical portion has a spiral groove provided in an inner circumferential surface of the cylindrical portion. Each of a cutting start point of the spiral groove and a cutting end point of the spiral groove is shifted by a predetermined degree in a circumferential direction of the cylindrical portion from a point. The point is on a line on which a plane intersects with the inner circumferential surface of the cylindrical portion. The point is at an end of the cylindrical portion. The plane includes an axis of the cylindrical portion and a mesh point at which the side gear meshes with the pinion gear.

With the above arrangement, each of a cutting start point of the spiral groove and a cutting end point of the spiral groove is shifted by a predetermined degree in a circumferential direction of the cylindrical portion from a point. The point is on a line on which a plane intersects with the inner circumferential surface of the cylindrical portion. The point is at an end of the cylindrical portion. The plane includes an axis of the cylindrical portion and a mesh point at which the side gear meshes with the pinion gear.

Therefore, the contact area of the sliding portion between the cylindrical portion of the differential case and the drive shaft is increased. Accordingly, the contact pressure of the sliding portion is reduced, and wear or seizure is less likely or unlikely to occur in the sliding portion.

In the differential gear unit according to the first aspect of the invention, the biasing device may be a disc spring. In the differential gear unit including the disc spring as the biasing device, the side gear is inclined due to the bias force of the disc spring, and the drive shaft fitted in the side gear is likewise inclined. Accordingly, a load generated from the bias force of the disc spring is applied to the sliding portion between the drive shaft and the cylindrical portion of the differential case. However, since the contact area of the sliding portion is increased, the contact pressure is also reduced. Accordingly, even with the arrangement in which the disc spring is interposed between the side gear and the differential case, wear or seizure is less likely or unlikely to occur in the sliding portion between the cylindrical portion of the differential case and the drive shaft.

In the differential gear unit according to the first aspect of the invention, the predetermined degree may be equal to or larger than 45 degrees and less than 135 degrees. Thus, each of the phase of the cutting start point and the phase of the cutting end point is shifted by the predetermined degree from the mesh point, the predetermined degree may be equal to or larger than 45 degrees and less than 135 degrees, so that the sliding portion and the cutting start point and cutting end point are separated in the circumferential direction from each other, and an influence of the cutting start point or cutting end portion is reduced.

A differential gear unit according to a second aspect of the invention includes a differential case, at least two pinion gears, a pair of side gears, a drive shaft, a biasing device, and a cylindrical portion. The at least two pinion gears are fitted on a pinion shaft fixed to the differential case. The side gears mesh with the pinion gears. The drive shaft is fitted in and connected to each of the side gears. The biasing device is disposed between a back face of each of the side gears and the differential case in a pre-loaded condition. The cylindrical portion is provided in the differential case. The cylindrical portion is configured to permit the drive shaft to be fitted in the cylindrical portion. The cylindrical portion has a spiral groove provided in an inner circumferential surface of the cylindrical portion. Each of a cutting start point of the spiral groove and a cutting end point of the spiral groove is spaced by a predetermined degree from a sliding portion, the drive shaft being configured to slide against the cylindrical portion at the sliding portion by meshing the side gear with the pinion gear.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a differential gear unit of a vehicle as one embodiment of the invention, showing an internal structure of the differential gear unit with a part of a differential case being cut off;

FIG. 2A and FIG. 2B are cross-sectional views simply showing a condition in which a drive shaft is spline-fitted in a side gear, in the differential gear unit of FIG. 1;

FIG. 3 is a view corresponding to those of FIG. 2A and FIG. 2B, showing a condition in which the side gear is inclined;

FIG. 4 is a view showing the positions at which a cutting start point and a cutting end point of a spiral groove formed in a cylindrical portion of a differential case are formed, in the differential gear unit of FIG. 1;

FIG. 5 is a perspective view showing the cylindrical portion of FIG. 5;

FIG. 6 is a view showing the relationship between the phase at which the cutting start point is formed, and the contact area between the drive shaft and the cylindrical portion; and

FIG. 7 is a view in which a PV value of a differential gear unit of a comparative example is compared with that of the differential gear device of the embodiment of FIG. 1.

### DETAILED DESCRIPTION OF EMBODIMENTS

It cannot be strictly stated that mesh points lie on a plane including the axis of a pinion shaft and the axis of side gears. However, it is well known that the mesh points are located in the vicinity of the plane including the axis of the pinion shaft and the axis of the side gears. Thus, in the following description, the mesh points are supposed to be located on the plane including the axis of the pinion shaft and the axis of the side gears (or the axis of cylindrical portions of a differential case).

In the following, one embodiment of the invention will be described in detail with reference to the drawings. In the drawings, respective parts of the following embodiment are simplified or deformed as needed, and the ratios of dimensions, shapes, etc. of the respective parts are not necessarily accurately depicted.

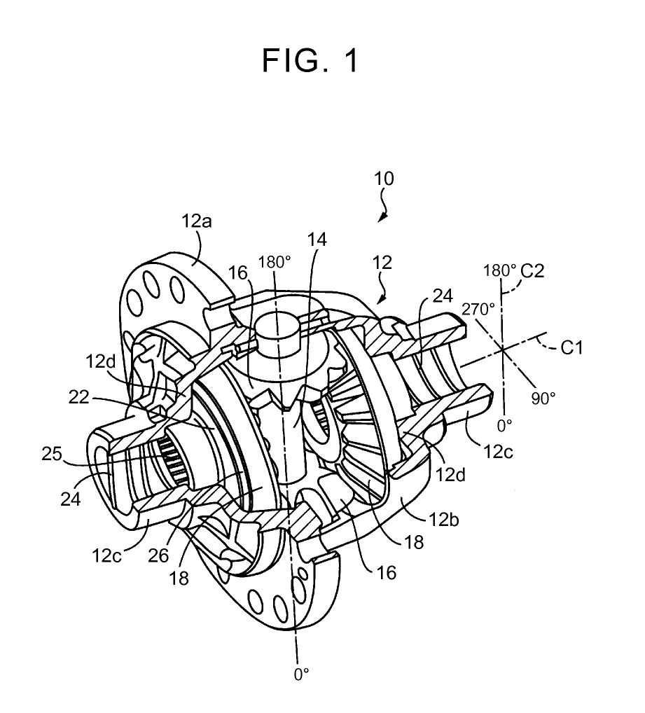

FIG. 1 is a perspective view of a differential gear unit 10 of a vehicle as one embodiment of the invention. In FIG. 1, a part of a differential case 12 of the differential gear unit 10 is cut off (and its cross-sectional surfaces are indicated by hatched lines), so that the internal structure of the gear unit 10 is shown. The differential gear unit 10 is disposed between a propeller shaft (not shown) and right and left wheels (not shown). In operation, the differential gear unit 10 gives a suitable difference in the rotational speed to the right and left wheels during turning of the vehicle so as to achieve smooth turning. In FIG. 1, drive shafts 20 that are spline-fitted in the side gears 18 as will be described later are not illustrated.

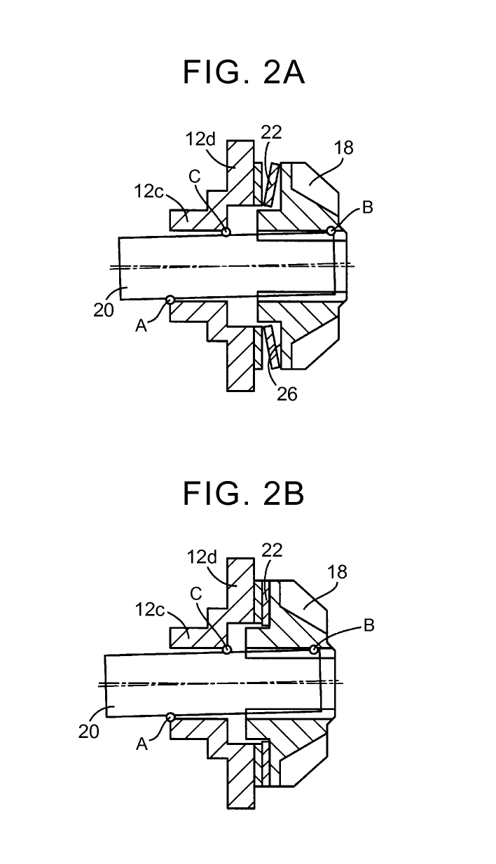

The differential gear unit 10 includes the differential case 12 that also functions as a protective member of the differential gear unit 10, two pinion gears 16, a pair of side gears 18, a pair of drive shafts 20 (see FIG. 2), and disc springs 22. The pinion gears 16 are fitted on a pinion shaft 14 fixed to the differential case 12, such that the pinion gears 16 are rotatable about the axis of the pinion shaft 14. The side gears 18 mesh with the pinion gears 16 while being rotatably supported by the differential case 12. End portions of the drive shafts 20 are connected by spline engagement to the respective side gears 18. Each of the disc springs 22 is disposed between a back face of the corresponding side gear 18 and the differential case 12 in a pre-loaded condition.

The differential case 12 includes a disc-like flange portion 12a, a cylindrical main body 12b, a pair of cylindrical portions 12c, and a pair of wall portions 12d. A differential driven gear (not shown) is connected to an outer peripheral portion of the flange portion 12a. An inner circumferential end of the flange portion 12a is connected to the outer periphery of the main body 12b. The cylindrical portions 12c are located at the opposite right and left ends of the main body 12b, and the center axis of the cylindrical portions 12c coincides with the center axis of the flange portion 12a. The wall portions 12d connect the main body 12b with the cylindrical portions 12c. When the propeller shaft (not shown) rotates, the differential case 12 is rotated about the axis of the flange portion 12a and the cylindrical portions 12c, via a differential drive gear and a differential driven gear (not shown). The drive shafts 20 are fitted in the respective cylindrical portions 12c, so as to be held in position. A spiral groove 24 for lubrication is provided in an inner circumferential surface of each of the cylindrical portions 12c. The spiral groove 24 is continuously provided so as to communicate with the axially opposite ends of the corresponding cylindrical portion 12c.

The pinion shaft 14 passes through the internal space of the main body 12b of the differential case 12, and the opposite ends of the pinion shaft 14 are fixed to the main body 12b. Accordingly, the pinion shaft 14 revolves along with the differential case 12. The pinion gears 16 are in the form of bevel gears, and are fitted on the pinion shaft 14 that passes through the pinion gears 16. The pinion gears 16 are able to rotate about the axis of the pinion shaft 14. Namely, the pinion gears 16 are able to rotate relative to the pinion shaft 14.

The above-indicated pair of side gears 18 are in the form of bevel gears. The side gears 18, which are rotatably supported by the cylindrical portions 12c of the differential case 12, mesh with the pinion gears 16. Each of the side gears 18 is provided at its inner circumferential portion with spline teeth 25 used for spline engagement with the drive shaft 20.

The disc spring 22 is formed in a cone-like shape, and is disposed between the back face 26 of the side gear 18 and the wall portion 12d of the differential case 12 in a pre-loaded condition. With the disc spring 22 thus disposed, backlash between the side gear 18 and the pinion gears 16 is reduced. In a region where the bias force of the disc spring 22 is larger than the reaction forces generated by meshing of the side gear 18 with the pinion gears 16, in particular, the backlash is always made equal to zero. The disc spring 22, when its bias force is suitably adjusted, also functions as a differential limiting mechanism that limits the differential operation of the differential gear unit 10. The disc spring 22 is one example of the biasing device of the invention.

FIG. 2A and FIG. 2B are cross-sectional views simply illustrating a condition where the drive shaft 20 is spline-fitted in the side gear 18, in the differential gear unit 10 of FIG. 1. FIG. 2A shows a condition where the bias force of the disc spring 22 is larger than the reaction forces generated by meshing of the side gear 18 with the pinion gears 16. FIG. 2B shows a condition where the reaction forces due to meshing of the side gear 18 with the pinion gears 16 is larger than the bias force of the disc spring 22.

While the vehicle is traveling in a high torque region, the reaction forces generated by meshing of the side gear 18 with the pinion gears 16 is larger than the bias force of the disc spring 22, so that the differential gear unit 10 is brought into the condition of FIG. 2B. At this time, only slipping in the circumferential direction occurs during turning of the vehicle, at a sliding portion A and a sliding portion C, between the cylindrical portion 12c of the differential case 12 and the drive shaft 20. The reason why the drive shaft 20 is inclined will be described later.

While the vehicle is traveling in a low torque region, on the other hand, the differential gear unit 10 switches between the condition (FIG. 2A) where the bias force of the disc spring 22 is larger than the reaction forces due to meshing of the side gear 18 with the pinion gears 16, and the condition (FIG. 2B) where the meshing reaction forces are larger than the bias force of the disc spring 22. At this time, slipping (sliding) in the axial direction of the drive shaft 20, in addition to slipping in the circumferential direction during turning, occurs at the sliding portion A and the sliding portion C, between the cylindrical portion 12c of the differential case 12 and the drive shaft 20.

In FIG. 2A and FIG. 2B, the axis of the side gear 18 coincides with the axis of the cylindrical portion 12c. However, the side gear 18 is actually inclined relative to the axis of the cylindrical portion 12c, as shown in FIG. 3. This is because a difference arises in the amount of displacement of the disc spring 22, due to a phase difference or meshing error of the upper and lower mesh points 28 of the side gear 18, and the side gear 18 is inclined on a plane that passes the upper and lower mesh points 28. Since the side gear 18 is inclined relative to the axis of the cylindrical portion 12c, the drive shaft 20 that is spline-fitted in the side gear 18 is also inclined. Thus, as shown in FIG. 2A and FIG. 2B, the drive shaft 20 is brought into sliding contact with the sliding portion A and the sliding portion C at the opposite ends of the cylindrical portion 12c, on the plane that passes the mesh points 28 and the axis of the cylindrical portion 12c. The inclination of the side gear 18 as described above is peculiar to the arrangement in which the disc spring 22 is disposed between the back face of the side gear 18 and the inner surface of the differential case 12. In this connection, since the drive shaft 20 is also inclined, the contact pressure P is more likely to be increased as compared with an arrangement that does not include the disc spring 22.

In a differential gear unit of a comparative example, the circumferential positions (phases) of the cutting start point and cutting end point of the spiral groove provided in the inner circumferential surface of the cylindrical portion are not taken into consideration. For example, when the phase of the cutting start point or cutting end point in the circumferential direction is the same as the phase of a mesh point of the side gear and the pinion gear in the circumferential direction, a sliding portion between the drive shaft and the cylindrical portion and the cutting start point or cutting end point overlap each other, resulting in reduction of the contact area S of the sliding portion. In this condition, if slipping (sliding) in the circumferential direction and slipping (sliding) in the axial direction occur in sliding portions between the cylindrical portion and the drive shaft, during turning of the vehicle in a low torque region, the contact pressures P at the sliding portions (corresponding to the sliding portion A and the sliding portion C in FIGS. 2A and 2B) are increased. Accordingly, these sliding portions are likely to wear, and seizure is likely to occur due to foreign matters produced by the wear. Thus, in the differential gear unit 10, the spiral groove 24 is provided such that the phases of the cutting start point 30 and cutting end point 32 of the spiral groove 24 formed in the cylindrical portion 12c becomes different from the phases of the mesh points 28 between the side gear 18 and the pinion gears 16.

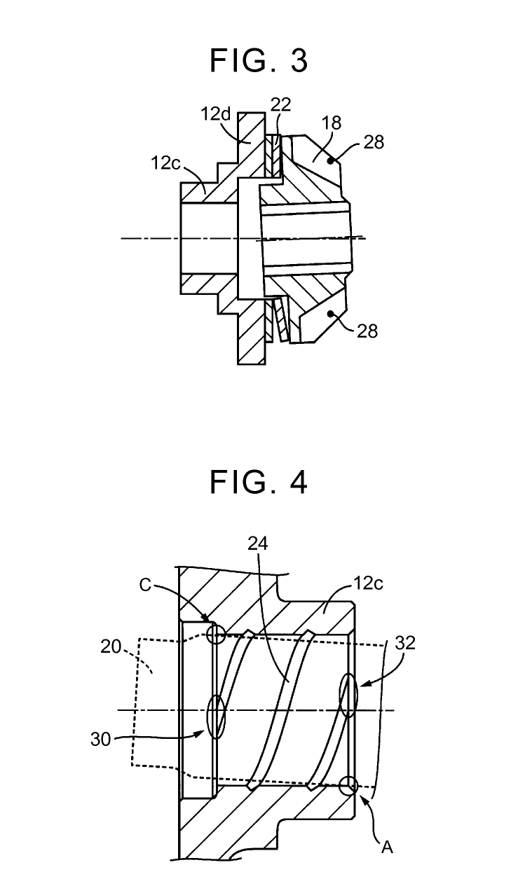

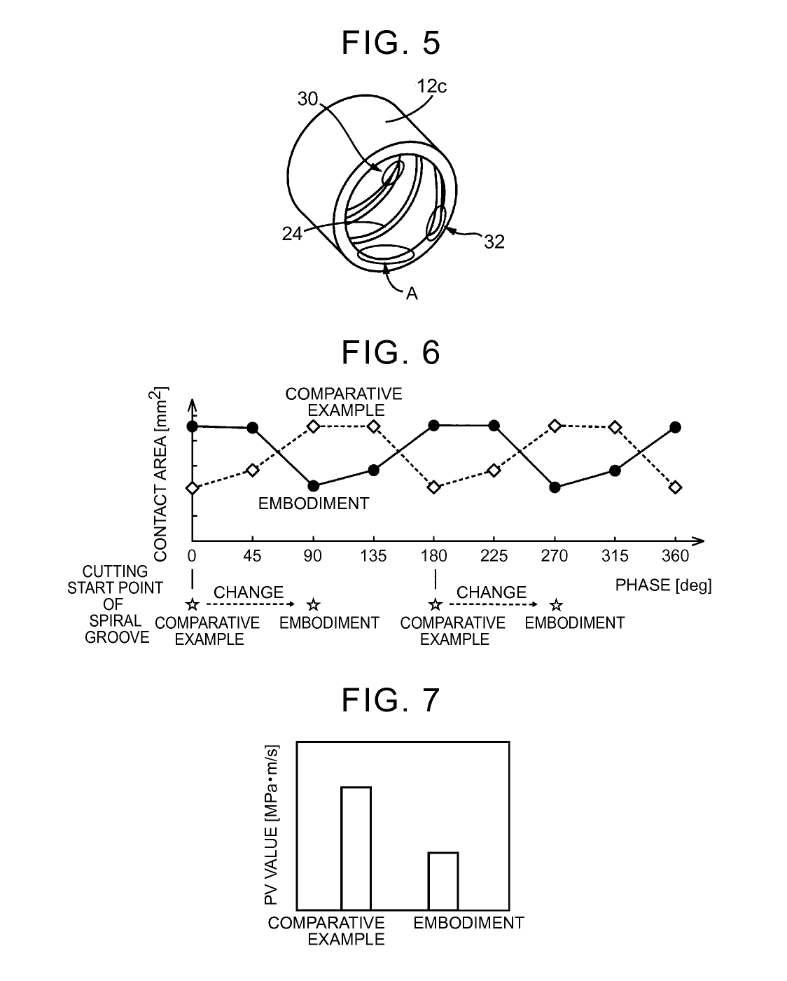

FIG. 4 shows the positions at which the cutting start point 30 and cutting end point 32 of the spiral groove 24 are provided in the cylindrical portion 12c of the differential case 12. In FIG. 4, the drive shaft 20 is indicated by a broken line for reference. As shown in FIG. 4, the drive shaft 20 indicated by the broken line contact with the cylindrical portion 12c at the sliding portion A and the sliding portion C since the drive shaft 20 is inclined on the plane that passes the mesh points 28 and the axis of the cylindrical portion 12c. While the vehicle is turning in a low torque region, slipping (sliding) in the circumferential direction and axial direction of the drive shaft 20 occurs at the sliding portion A and the sliding portion C. On the other hand, the cutting start point 30 is formed at a position at which the phase of the cutting start point 30 is shifted by about 90 degrees from that of the sliding portion C. In other words, the cutting start point 30 is formed at a position that is spaced by about 90 degrees in the circumferential direction, from the plane that passes the mesh points 28 and the axis of the cylindrical portion 12c. Also, the cutting end point 32 is formed at a position at which the phase of the cutting end point 32 is shifted by about 90 degrees from that of the sliding portion A. In other words, the cutting end point 32 is formed at a position that is spaced by about 90 degrees in the circumferential direction, from the plane that passes the mesh points 28 and the axis of the cylindrical portion 12c. FIG. 5 is a perspective view simply showing the cylindrical portion 12c of FIG. 4. With the cutting start point 30 and cutting end portion 32 formed at the positions as shown in FIG. 4 and FIG. 5, the contact areas S at the sliding portions are increased, as compared with the case where the cutting start point 30 and the cutting end point 32 are formed at positions having the same phases of the sliding portions A, C.

FIG. 6 shows the relationship between the phase at which the cutting start point 30 is formed, and the contact area S of the sliding portion C between the drive shaft 20 and the cylindrical portion 12c. In FIG. 6, the horizontal axis indicates the phase on the inner circle of the cylindrical portion 12c, and the vertical axis indicates the contact area S between the cylindrical portion 12c and the drive shaft 20. On the inner circle of the cylindrical portion 12c, the positions on a line that passes the axis C1 of the cylindrical portion 20c shown in FIG. 1 and overlaps line C2 parallel with the axis of the pinion shaft 14 are set to 0 degree and 180 degrees as reference phases. Namely, on the inner circle of the cylindrical portion 12c, the positions of the upper and lower mesh points 28 of the side gear 18 and the pinion gears 16 are set to 0 degree and 180 degrees in phase.

In FIG. 6, the broken line indicates the relationship between the phase in the differential gear unit of the comparative example, and the contact area S. In the comparative example, the cutting start point 30 may be formed at a position of phase 0degree or phase 180 degree, for example. In this case, the contact area S is relatively small at phase 0 degree or phase 180 degree. Here, at phase 0 degree or phase 180 degrees of the cylindrical portion 12c, the drive shaft 20 is inclined due to the bias force of the disc spring 22, and a load is generated due to contact between the cylindrical portion 12c and the drive shaft 20. In this case, the contact pressure P is increased since the contact area S is small at phase 0 degree or phase 180 degrees. Accordingly, wear or seizure is likely to occur in the differential gear unit of the comparative example.

On the other hand, in FIG. 6, the solid line indicates the relationship between the phase in the differential gear unit 10 of this embodiment and the contact area S. In this embodiment, the cutting start point 30 is changed or shifted by 90 degrees, relative to the cutting start point of the comparative example indicated by the broken line. With the cutting start point 30 thus changed, the contact area S is increased at phase 0 degree or phase 180 degrees, as shown in FIG. 6. This is because the cutting start point 30 is not formed at the position of phase 0 degree or phase 180 degrees. A load is generated between the cylindrical portion 12c and the drive shaft 20, at the position of phase 0 degree or phase 180 degrees. However, the contact area S at these phases is a large value, and therefore, the contact pressure P is reduced. Similarly, the cutting end point 32 is set to a position that is spaced or shifted by about 90 degrees from the position of phase 0 degree or phase 180 degrees. In this embodiment, the phases of the cutting start point 30 and the cutting end point 32 are set to positions shifted by 90 degrees from the phases (phase 0 degree and 180 degrees) of the mesh points 28. However, if the phases of the cutting start point 30 and the cutting end point 32 are shifted by a degree that is equal to or larger than 45 degrees and less than 135 degrees from the phases of the mesh points 28, the cutting start point 30 and the cutting end point 32 are sufficiently spaced in the circumferential direction from the sliding portions A, C, and the contact pressure P is reduced. When two pinion gears 16 are provided, as in this embodiment, the phases of the cutting start point 30 and the cutting end point 32 are preferably shifted by a degree that is equal to or larger than 45 degrees and less than 135 degrees. These angles may be changed if the number of pinion gears is changed. More specifically, where the number of pinion gears is N, the cutting start point 30 and the cutting end point 32 are preferably set to positions that are shifted by 180/(2N) degrees or larger and 270/N degrees from the phases of the mesh points 28.

In FIG. 7, the PV value of the differential gear unit of the comparative example is compared with that of the differential gear unit 10 of this embodiment. The

PV value represents the product of the contact pressure P, and the slipping velocity V at a sliding portion between the cylindrical portion 12c and the drive shaft 20, and wear and seizure are more likely to occur as the PV value is higher. As shown in FIG. 7, in the differential gear unit 10 of this embodiment, the PV value is reduced to about a half of that of the differential gear unit of the comparative example. Namely, the possibility of occurrence of wear and seizure is significantly reduced.

As described above, according to this embodiment, the cutting start point 30 or cutting end point 32 of the spiral groove 24 is formed at a position that is different in the circumferential direction from the sliding portions A, C between the cylindrical portion 12c of the differential case 12 and the drive shaft 20, so that the contact areas S of the sliding portions A, C between the cylindrical portion 12c of the differential case 12 and the drive shaft 20 are increased. Accordingly, the contact pressures P at the sliding portions A, C are reduced, and therefore, wear or seizure is less likely or unlikely to occur at the sliding portions A, C.

In the differential gear unit 10 of this embodiment including the disc spring 22 between the side gear 18 and the differential case 12, the side gear 18 is inclined due to the bias force of the disc spring 22, and the drive shaft 20 fitted in the side gear 18 is likewise inclined. As a result, loads due to the bias force of the disc spring 22 are applied to the sliding portions A, C between the drive shaft 20 and the cylindrical portion 12c of the differential case 12. However, since the contact areas S of the sliding portions A, C are increased, the contact pressures P are also reduced. Accordingly, even with the arrangement in which the disc spring 22 is disposed between the side gear 18 and the differential case 12, wear or seizure that would occur at the sliding portions A, C between the cylindrical portion 12c of the differential case 12 and the drive shaft 20 can be curbed or prevented.

According to this embodiment, the phase of the cutting start point 30 or the cutting end point 32 is set to the position that is spaced or shifted by a degree that is equal to or larger than 45 degrees and less than 135 degrees (more specifically, 90 degrees) from the phase of the mesh point 28. Accordingly, the sliding portions A, C and the cutting start point 30 or the cutting end point 32 are sufficiently spaced apart from each other, and therefore, an influence of the cutting start point 30 or the cutting end point 32 is further reduced.

While one embodiment of the invention has been described in detail with reference to the drawings, this invention may be embodied in other forms.

While two pinion gears 16 are provided in the illustrated embodiment, the number of the pinion gears 16 is not particularly limited, but may be three or more.

While the disc spring 22 is used as the biasing device in the illustrated embodiment, the biasing device is not necessarily limited to the disc spring 22, but may be changed as appropriate provided that it can generate bias force. For example, the biasing device may be a rubber member, or coil springs that are arranged at equal angular intervals in the circumferential direction.

In the illustrated embodiment, the cutting start point 30 and the cutting end point 32 are formed at positions that are spaced by 90 degrees from the sliding portions A, C. However, the degree of spacing is not limited to this numerical value. Nonetheless, it is preferable that the phase is shifted by 45 degrees or larger, even in the differential gear unit provided with two pinion gears as in this embodiment.

It is to be understood that the above-described embodiment is a mere exemplary embodiment, and that this invention may be embodied with various other changes or improvements, based on the knowledge of those skilled in the art.

What is claimed is:

1. A differential gear unit comprising:
a differential case;
at least two pinion gears fitted on a pinion shaft fixed to the differential case;
a pair of side gears that mesh with the pinion gears;
a drive shaft fitted in and connected to each of the side gears;
a biasing device disposed between a back face of each of the side gears and the differential case in a pre-loaded condition; and
a cylindrical portion provided in the differential case, the cylindrical portion being configured to permit the drive shaft to be fitted in the cylindrical portion, the cylindrical portion having a spiral groove provided in an inner circumferential surface of the cylindrical portion, each of a cutting start point of the spiral groove and a cutting end point of the spiral groove being shifted by a predetermined degree in a circumferential direction of the cylindrical portion from a point, the point being on a line on which a plane intersects with the inner circumferential surface of the cylindrical portion, the point being at an end of the cylindrical portion, the plane including an axis of the cylindrical portion and a mesh point at which the side gear meshes with the pinion gear.

2. The differential gear unit according to claim 1, wherein the biasing device comprises a disc spring.

3. The differential gear unit according to claim 1, wherein the predetermined degree is equal to or larger than 45 degrees and less than 135 degrees.

4. A differential gear unit comprising:
a differential case;
at least two pinion gears fitted on a pinion shaft fixed to the differential case;
a pair of side gears that mesh with the pinion gears;
a drive shaft fitted in and connected to each of the side gears;
a biasing device disposed between a back face of each of the side gears and the differential case in a pre-loaded condition; and
a cylindrical portion provided in the differential case, the cylindrical portion being configured to permit the drive shaft to be fitted in the cylindrical portion, the cylindrical portion having a spiral groove provided in an inner circumferential surface of the cylindrical portion, each of a cutting start point of the spiral groove and a cutting end point of the spiral groove being spaced by a predetermined degree from a sliding portion, the drive shaft being configured to slide against the cylindrical portion at the sliding portion by meshing the side gear with the pinion gear.
